(19) United States
(12) Patent Application Publication
(10) Pub. No.: US 2011/0220009 A1
(43) Pub. Date: Sep. 15, 2011

(54) INDICATOR MOTION ARCHITECTURE FOR VEHICLE SYSTEM STATUS INDICATION

(75) Inventors: Stephen Lee Betts, Canton, MI (US); Alfredo Perez, Belleville, MI (US)

(73) Assignee: VISTEON GLOBAL TECHNOLOGIES, INC., Van Buren Twp., MI (US)

(21) Appl. No.: 12/722,576

(22) Filed: Mar. 12, 2010

(51) Int. Cl. G01D 5/00

(52) U.S. Cl. 116/282

(57) ABSTRACT

A motion system includes a semi-rigid actuator member movable along a pre-determined path, an indicator coupled to the actuator member, a rigid guide device disposed adjacent the actuator member to direct the actuator member along the pre-determined path, and a drive device for engaging the actuator member to selectively cause the indicator to move along the pre-determined path.

### FIELD OF THE INVENTION

The present invention generally relates to a display. In particular, the invention is directed to a motion system for controlling a position of an indicator of a display.

### BACKGROUND OF THE INVENTION

In general, an automotive vehicle includes various gauges or meters mounted on an instrument panel constituting the front surface of an instrument cluster. Pointer-type gauges are widely used for speedometers, RPM tachometers, temperature gauges, fuel gauges, etc.

In general, a pointer needle (i.e. indicator) is rotatably mounted at a pointer shaft installed at the center of a character plate so as to rotate about the point shaft above the character plate having a scale and characters thereon. The pointer needle rotates by means of a step motor mounted below the character plate, and is controlled by a micro computer. However, indicators (e.g. pointers) for a vehicle display are typically limited to radial movement.

It would be desirable to develop a motion system for an indicator to apply a motion control and a closed loop feedback to the indicator, thereby providing a freedom in defining a path of motion for the indicator.

### SUMMARY OF THE INVENTION

Concordant and consistent with the present invention, a motion system for an indicator to apply a motion control and a closed loop feedback to the indicator, thereby providing a freedom in defining a path of motion for the indicator, has surprisingly been discovered.

In one embodiment, a motion system comprises: a semi-rigid actuator member movable along a pre-determined path; an indicator coupled to the actuator member; a guide device disposed adjacent the actuator member to direct the actuator member along the pre-determined path; and a drive device for engaging the actuator member to selectively cause the indicator to move along the pre-determined path.

In another embodiment, a motion system comprises: a semi-rigid tape movable along a pre-determined path and having a plurality of apertures formed therein; an indicator coupled to the tape; a guide device disposed adjacent the tape to direct the tape along the pre-determined path; and a drive device for engaging the actuator member to selectively cause the indicator to move along the pre-determined path.

In yet another embodiment, a motion system comprises: a semi-rigid actuator member movable along a pre-determined path and having a plurality of gear ridges formed therein; an indicator coupled to the actuator member; a guide device disposed adjacent the actuator member to direct the actuator member along the pre-determined path; and a drive device having a pinion for selectively engaging the gear ridges of the gear ridges of the actuator member to cause the indicator to move along the pre-determined path.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic representation of a display according to an embodiment of the present invention;

FIG. 2 is a fragmentary perspective view of a motion system of the display of FIG. 1;

FIG. 3 is a side cross sectional view of the motion system of FIG. 2;

FIG. 4 is a fragmentary rear elevational view of the motion system FIG. 2;

FIG. 5 is a fragmentary front perspective view of a positional feedback device according to an embodiment of the present invention;

FIG. 6 is a fragmentary front perspective view of a positional feedback device according to another embodiment of the present invention;

FIG. 7 is a fragmentary front perspective view of a positional feedback device according to another embodiment of the present invention; and

FIG. 8 is a fragmentary perspective view of a motion system according to another embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

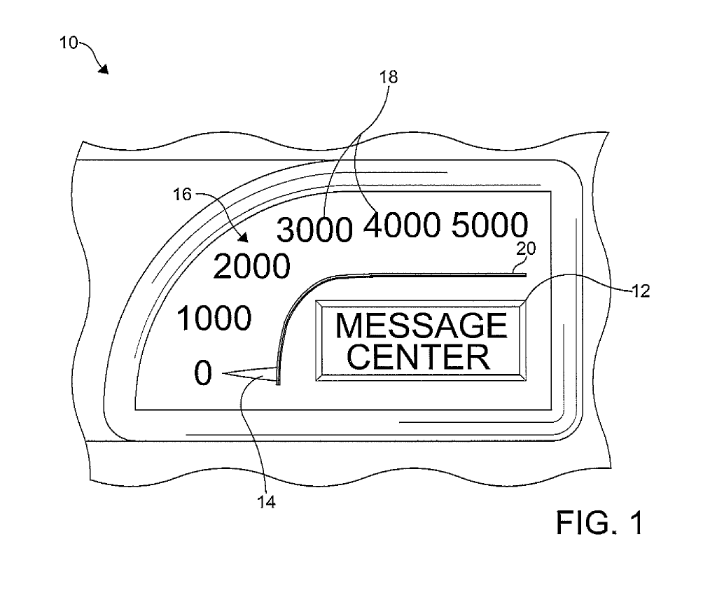

FIG. 1 illustrates a display 10 according to an embodiment of the present invention. As a non-limiting example, the display 10 is disposed in an instrument cluster of a vehicle for indicating a condition of the vehicle to an operator. As shown, the display 10 includes a message center 12, an indicator 14, and an appliqué 16 including indicia 18 for communicating a vehicle condition to the operator.

The message center 12 may be any device or system for providing a visual feedback to the operator relating to a vehicle condition or a vehicle system. As a non-limiting example, the message center 12 is a liquid crystal display. However, other displays known in art can be used. As a further example, the message center 12 includes a plurality of tell tales (not shown). It is understood that the tell tales may be formed in the appliqué 16.

The indicator 14 is an instrument pointer that cooperates with the indicia 18 on the appliqué 16 to communicate the vehicle condition to the operator. As shown, the indicator 14 is caused to follow a pre-determined indicator path 20. As a non-limiting example, the indicator path 20 non-linear. However, the indicator 14 may be caused to follow any path.

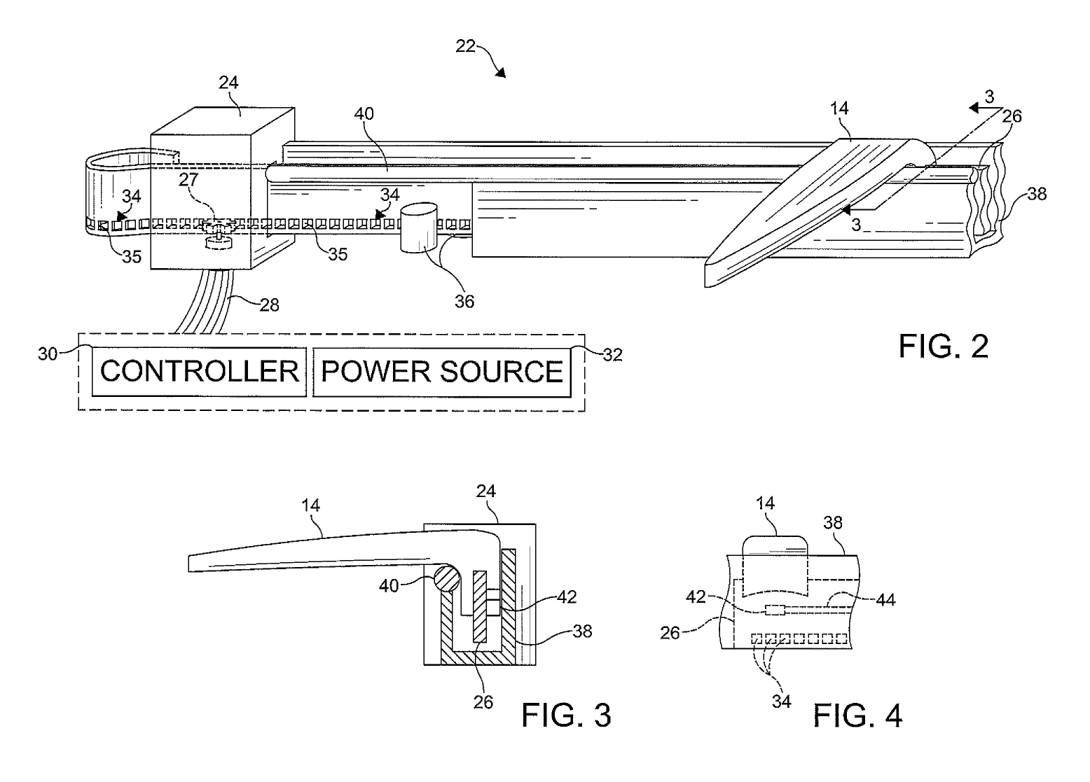

FIGS. 2-4 illustrate a motion system 22 for moving the indicator 14 along the indicator path 20. As shown, the motion system 22 includes a drive device 24 and an actuator member 26.

The drive device 24 is typically a motor having means for selectively engaging the actuator member 26 to cause the indicator 14 to move along the indicator path 20. As a non limiting example the drive device 24 is a position controlled stepper motor having a pinion 27 to engage the actuator member 26. As a further example, the drive device 24 is an ultrasonic motor.

A plurality of electrical connectors 28 are electrical coupled to the drive device 24. As a non-limiting example, the drive device 24 is in signal communication with a controller 30 and a power source 32 to provide control signals and electrical power respectively thereto. It is understood that the drive device 24 may be in electrical and signal communication with any number of devices and systems.

The actuator member 26 is a semi-rigid tape coupled to the indicator 14, wherein a motion of the actuator member 26 causes a motion of the indicator 14 coupled thereto. Semi-rigid is defined as having a level of flexibility to follow a curve in at least one dimension and a level of rigidity to minimize a stretch or a compression thereof, whereby the drive device 24 is capable of both “pushing” and “pulling” the tape without requiring a pair of pulleys to wind the tape therebetween. As a non-limiting example, the actuator member 26 is formed from mylar having a pre-determined thickness. As a further example, the actuator member 26 is formed from a molding process or a stamping process.

As shown, the actuator member 26 includes a plurality of apertures 34, wherein each of the apertures 34 is defined by a wall 35 formed in the actuator member 26. In certain embodiments, teeth of the pinion 27 are received in the apertures 34 and engage the walls 35 defining the apertures 34 to cause the actuator member 26 to move. In certain embodiments, the actuator member 26 includes a rigid gear rack having gear ridges that are engaged by the drive means 24.

The motion system 24 also includes at least one guide device 36, 38, 40 for controlling the motion of the indicator 14 along the pre-determined path 20. As shown, a pair of guide rollers 36 are disposed on opposite sides of the actuator member 26 to retain the actuator member 26 therebetween.

A guide wall 38 is disposed adjacent the actuator member 26 to limit a motion of the actuator member 26 in a particular dimension or dimensions. For example, the guide wall 38 is shown having a generally “J” shaped cross-section, wherein the actuator member 26 is disposed in a curve of the “J”. It is understood that the guide wall 38 can have any size, shape, and cross section. It is further understood that the guide wall 38 may be integrated into a component of the vehicle.

A guide rail 40 is disposed adjacent the actuator member 26, wherein the indicator 14 “rides” or tracks the guide rail 40 along a shape thereof. As a non-limiting example, the guide rail 40 is coupled to the guide wall 38. It is understood that a shape of the guide rail 40 represents the pre-determined indicator path 20. It is further understood that the guide rail 40 may be integrated into a component of the vehicle.

As more clearly shown in FIGS. 3-4, a light source 42 is disposed on the actuator member 26 adjacent the indicator 14, wherein light emitted from the light source 42 illuminates at least a portion of the indicator 14. As a non-limiting example, the light source 42 is a light emitting diode (LED) such as a side emitting LED. However, any light source can be used.

A conductive trace 44 is disposed on the actuator member 26 to provide electrical power to the light source 42. As a non-limiting example, the conductive trace 44 extends along a length of the actuator member 26 and terminates at a static end of the actuator member 26 coupled to a static element. Accordingly, any curve, bend, or spooling of the actuator member 26 does not disrupt the flow of electrical current to the light source 42.

In use, the drive device 24 engages the actuator member 26 to cause the actuator member 26 to move. As the actuator member 26 moves, the indicator 14 coupled thereto also moves. The rigidity of the actuator member 26 supports the indicator 14 in one dimension, while at least one guide device 36, 38, 40 directs the actuator member 26 along the predetermined indicator path 20. In certain embodiments, a position of the indicator 14 relative to the drive device 24 is determined by a number of rotations of the drive device 24. However, other means of determining a relative position of the indicator 14 along the indicator path 20 can be used.

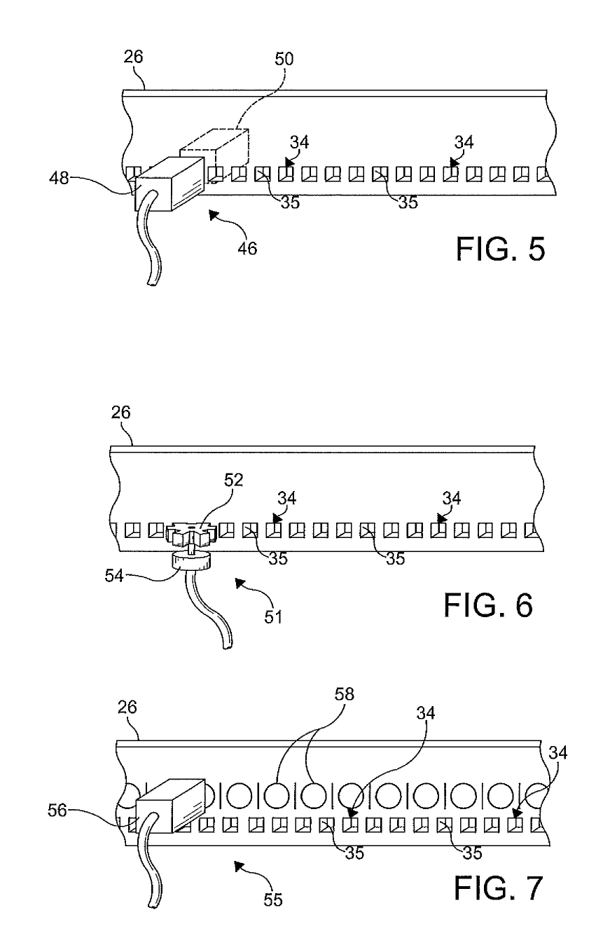

FIG. 5 illustrates a positional feedback device 46 disposed adjacent the actuator member 26 of the motion system 22, according to an embodiment of the present invention. The positional feedback device 46 is an optical sensor device having a light source 48 disposed adjacent the actuator member 26 and a sensor 50 disposed adjacent the actuator member 26 opposite the light source 48. In use, the light source 48 emits light toward the actuator member 26. As the apertures 34 of the actuator member 26 move through the emitted light, the sensor 50 detects a pulsed light pattern caused by the emitted light being blocked by a portion of the actuator member 26 and passing through one of the apertures 34. Based upon the detection of light and darkness, information from the sensor 50 can be used to calculate a relative position of the actuator member 26, and thereby a position of the indicator 14.

FIG. 6 illustrates a positional feedback device 51 disposed adjacent the actuator member 26 of the motion system 22 according to another embodiment of the present invention. The positional feedback device 51 includes a pinion 52 coupled to an encoder 54. In use, the pinion 52 engages the walls 35 defining the apertures 34 of the actuator member 26. As the actuator member 26 moves, the pinion 52 is rotated and the encoder 54 generates a pulse representing a positional information of the actuator member 26 and the indicator 14. A position of the actuator member 26 can be determined by analyzing a pulse data generated by the encoder 54.

FIG. 7 illustrates a positional feedback device 55 including a magnetic sensor 56 disposed adjacent the actuator member 26 according to another embodiment of the present invention. As shown, a plurality of magnetic devices 58 are coupled to the actuator device 26. In certain embodiments, the actuator member 26 includes integrated magnetic elements. In use, the magnetic sensor 56 detects the magnetic field of the magnetic devices 58 as the actuator member 26 passes through a sensing zone thereof. As a non-limiting example a pulse pattern can be created by the magnetic fields of the magnetic devices 58 as the actuator member 26 passes through the sensing zone of the magnetic sensor 56. A position of the actuator member 26 can be determined by analyzing a pulse data collected by the sensor 56.

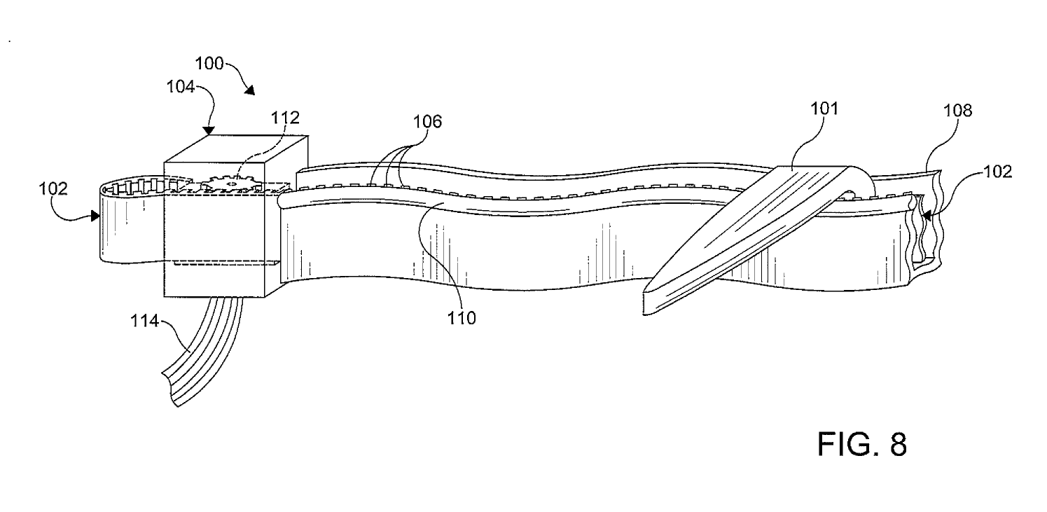

FIG. 8 illustrates a motion system 100 for moving an indicator 101 along an indicator path according to another embodiment of the present invention. As shown, the motion system 100 includes an actuator member 102 and a drive device 104.

The actuator member 102 is a semi-rigid gear rack having a plurality of gear ridges 106. As a non-limiting example, the gear ridges 106 are equally spaced protrusions disposed on a surface of the actuator member 102. As shown, the actuator member 102 is caused to follow a “wavy”, non-circular path. However, the actuator member 102 can be caused to follow any path such as a linear path, a non-linear path, and a radial path, for example.

The motion system 100 also includes at least one guide device 108, 110 for controlling the motion of the indicator 101 along the pre-determined path.

A guide wall 108 is disposed adjacent the actuator member 102 to limit a motion of the actuator member 102 in a particular dimension or dimensions. For example, the guide wall 108 is shown having a generally “J” shaped cross-section, wherein the actuator member 102 is disposed in a curve of the “J”. It is understood that the guide wall 108 can have any size, shape, and cross section. It is further understood that the guide wall 108 may be integrated into a component of the vehicle.

A guide rail 110 is disposed adjacent the actuator member 102, wherein the indicator 101 “rides” or tracks the guide rail 110 along a shape thereof. It is understood that a shape of the guide rail 110 represents the pre-determined indicator path.

The drive device 104 is typically a motor having means for selectively engaging the actuator member 102 to cause the indicator 101 to move along the pre-determined path. As a non limiting example, the drive device 104 is a positional controlled stepper motor having a pinion 112 to engage the gear ridges 106 of the actuator member 102. As a further example, the drive device 104 is an ultrasonic motor.

A plurality of electrical connectors 114 are electrical coupled to the drive device 104 to provide electrical power and control signals thereto. It is understood that the drive device 104 may be in electrical and signal communication with any number of devices and systems.

In use, the drive device 104 engages the actuator member 102 to cause the actuator member 102 to move. As the actuator member 102 moves, the indicator 101 coupled thereto also moves. The rigidity of the actuator member 102 supports the indicator 101 in at least one dimension, while at least one guide device 108, 110 directs the actuator member 102 along the predetermined indicator path. In certain embodiments, a position of the indicator 101 relative to the drive device 104 is determined by a number of rotations of the drive device 104. However, other means of determining a relative position of the indicator 101 along the indicator path can be used.

The motion systems 22, 100 provide a motion control and a closed loop feedback for the indicators 14, 101. The motion systems 22, 100 provides a freedom in defining a path of motion (e.g. linear and non-linear) for the indicators 14, 101 and is not limited to a radial or circular motion.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A motion system comprising:
a semi-rigid actuator member movable along a pre-determined path;
an indicator coupled to the actuator member;
a guide device disposed adjacent the actuator member to direct the actuator member along the pre-determined path; and
a drive device for engaging the actuator member to selectively cause the indicator to move along the pre-determined path.

2. The motion system according to claim 1, wherein the actuator member includes a gear rack having a plurality of gear ridges.

3. The motion system according to claim 1, wherein the actuator member includes a plurality of apertures and the drive device includes a pinion for engaging a wall forming each of the apertures.

4. The motion system according to claim 1, wherein the drive device is a stepper motor.

5. The motion system according to claim 1, wherein the drive device is an ultra-sonic motor.

6. The motion system according to claim 1, wherein the guide device includes an elongate rail formed into a shape representing the pre-determined path.

7. The motion system according to claim 1, wherein the guide device includes a guide track having a generally “J” shaped cross section, and wherein the actuator member is disposed in a curve of the “J” shaped cross section.

8. The motion system according to claim 1, wherein the guide device includes a pair of rollers disposed on opposite sides of the actuator member to retain the actuator member therebetween.

9. The motion system according to claim 1, further comprising a light source coupled to the actuator member adjacent the indicator.

10. The motion system according to claim 9, further comprising a conductive trace coupled to the actuator member and providing electrical communication between a power source and the light source.

11. The motion system according to claim 1, further comprising a positional feedback device disposed adjacent the actuator member to detect a position of the indicator.

12. The motion system according to claim 11, further comprising a plurality of magnetic devices coupled to the actuator member, wherein the positional feedback device includes a magnetic sensor for detecting the magnetic devices.

13. The motion system according to claim 11, wherein the actuator member includes a plurality of apertures formed therein and the positional feedback device includes an optical sensor to detect the apertures formed in the actuator member.

14. The motion system according to claim 11, wherein the actuator member includes a plurality of apertures formed therein and the positional feedback device includes a pinion coupled to a pulse generator.

15. The motion system according to claim 1, wherein the pre-determined path is a linear path.

16. A motion system comprising:
a semi-rigid tape movable along a pre-determined path and having a plurality of apertures formed therein;
an indicator coupled to the tape;
a guide device disposed adjacent the tape to direct the tape along the pre-determined path; and
a drive device for engaging the actuator member to selectively cause the indicator to move along the pre-determined path.

17. The motion system according to claim 16, wherein the drive device includes a pinion for engaging a wall forming each of the apertures of the actuator member.

18. The motion system according to claim 16, further comprising a positional feedback device disposed adjacent the actuator member to detect a position of the indicator.

19. A motion system comprising:
a semi-rigid actuator member movable along a pre-determined path and having a plurality of gear ridges formed therein;
an indicator coupled to the actuator member;
a guide device disposed adjacent the actuator member to direct the actuator member along the pre-determined path; and
a drive device having a pinion for selectively engaging the gear ridges of the gear ridges of the actuator member to cause the indicator to move along the pre-determined path.

20. The motion system according to claim 19, further comprising a positional feedback device disposed adjacent the actuator member to detect a position of the indicator.
